(19) United States
(12) Patent Application Publication
(10) Pub. No.: US 2024/0284156 A1
(43) Pub. Date: Aug. 22, 2024

(54) COMMUNICATION DEVICE AND COMMUNICATION METHOD

(71) Applicant: Panasonic Intellectual Property Management Co., Ltd., Osaka (JP)

(72) Inventors: Hiroyuki MOTOZUKA, Kanagawa (JP); Masataka IRIE, Kanagawa (JP); Kosei NAKANO, Kanagawa (JP)

(21) Appl. No.: 18/291,479

(22) PCT Filed: Jul. 14, 2022
(86) PCT No.: PCT/JP2022/027635

§ 371 Date: Jan. 23, 2024

(30) Foreign Application Priority Data
Jul. 28, 2021 (JP) 2021-123415

(51) Int. Cl. H04W 8/00; H04L 1/1607; H04W 4/06

(52) U.S. Cl. CPC H04W 8/005; H04L 1/1607; H04W 4/06

(57) ABSTRACT

The present invention groupcasts a groupcast frame in a short period of time by using millimeter wave communication. A communication device equipped with a MAC control circuit for controlling a procedure for discovering a communication partner device and a procedure for determining the best transmission sector, and also equipped with a wireless circuit for transmitting a unicast frame to the communication partner device by using the best transmission sector, wherein the MAC control circuit controls the wireless circuit so as to start a timer for each discovered communication partner device after the procedure for discovering communication partner devices is completed, and transmit a groupcast frame to communication partner devices for which the timer has not finished by using the best transmission sector upon receiving a groupcast frame transmission request from a higher layer before all timers have finished.

### TECHNICAL FIELD

The present disclosure relates to a communication apparatus and a communication method.

### BACKGROUND ART

A system of performing high-speed and low-delay communication using a wide frequency band in carrier frequencies equal to or higher than 10 GHz has been studied. For example, for a high-frequency band of 10 GHz or higher, taking advantage that the antenna can be miniaturized due to the short wave, and in order to avoid a large propagation loss and to expand a communication range, a beamforming technology using an antenna whose directivity can be electrically controlled has been studied.

Examples of a millimeter-wave wireless LAN communication standard using a 60 GHz band include the IEEE802.11ad-2012 standard (Non Patent Literature (hereinafter, referred to as NPL) 1). The IEEE802.11ad-2012 standard defines a beamforming protocol.

The IEEE802.11ad-2012 standard defines a method of sequentially transmitting directional multi gigabit (DMG) beacon frames while changing directivity, that is, sectors, using beamforming so that all directions in which a pseudo-omnidirectional antenna can transmit are covered. At this time, in order for a reception terminal to receive the DMG beacon frame even when the pseudo-omnidirectional antenna is used, the transmission terminal performs transmission using a control PHY frame having a low coding rate and a small number of multilevel modulation.

### CITATION LIST

### Patent Literature

PTL 1

Japanese Patent Application Laid-Open No. 2010-154520

### Non Patent Literature

NPL 1

IEEE802.11ad-2012

### SUMMARY OF INVENTION

### Technical Problem

In a case where a groupcast frame is transmitted to one or more surrounding receivable radio devices (hereinafter, referred to as groupcast), when groupcast frames are sequentially transmitted while directivity (sector) is changed by beamforming so that all directions in which a pseudo-omnidirectional antenna can transmit are covered, a large number of transmissions are repeated depending on the number of sectors, which takes time for the transmission. Note that the groupcast frame is a generic name of a multicast frame and a broadcast frame. The broadcast frame means a frame in which a destination address is different from each address of an individual terminal (e.g., all MAC addresses are “1”), and is, for example, a frame that transmits advertising information and radar information. The multicast frame is a frame that defines a protocol for joining and leaving a multicast group and transmits the same content to group participants.

A non-limiting embodiment of the present disclosure facilitates providing a communication apparatus and a communication method each capable of broadcasting a groupcast frame in a short time using millimeter-wave communication.

### Solution to Problem

A communication apparatus according to the present disclosure includes: MAC control circuitry, which, in operation, controls a procedure of discovering a communication partner apparatus and a procedure of determining a transmission best sector in which a radio communication quality with the communication partner apparatus is best; and radio circuitry, which, in operation, transmits a unicast frame to the communication partner apparatus using the transmission best sector, in which the MAC control circuitry starts a timer for each of a plurality of the discovered communication partner apparatuses after the procedure of discovering the communication apparatus is completed, and controls the radio circuitry to transmit a groupcast frame using the transmission best sector for the communication partner apparatus for which the timer has not expired, when receiving a request for transmitting the groupcast frame from a higher layer before all of a plurality of the timer expires.

It should be noted that general or specific embodiments may be implemented as a system, an apparatus, a method, an integrated circuit, a computer program, a storage medium, or any selective combination thereof.

### Advantageous Effects of Invention

According to an aspect of the present disclosure, it is possible to groupcast a groupcast frame in a short time using millimeter-wave communication.

### BRIEF DESCRIPTION OF DRAWINGS

FIG. 1 illustrates an exemplary system configuration of a V2X communication system according to an embodiment;

FIG. 2 illustrates an exemplary configuration of a communication apparatus conforming to the IEEE802.11ad standard;

FIG. 3 illustrates an exemplary method by which the communication apparatus conforming to the IEEE802.11ad standard performs beamforming;

FIG. 4 illustrates a procedure in which the communication apparatus sequentially transmits DMG beacon frames while changing sectors;

FIG. 5 illustrates a procedure in which the communication apparatus of the present embodiment performs broadcast transmission of a broadcast frame using transmission beamforming;

FIG. 6 illustrates a DMG beacon frame format used in OCB discovery by the communication apparatus of the present embodiment;

FIG. 7 illustrates an exemplary method by which the communication apparatus of the present embodiment controls link maintenance timers;

FIG. 8 illustrates an exemplary procedure in which the communication apparatus of the present embodiment transmits a broadcast frame;

FIG. 9A illustrates an antenna pattern and a positional relationship between communication apparatuses when the communication apparatus of the present embodiment transmits a CTS-to-self frame;

FIG. 9B illustrates an antenna pattern and a positional relationship between communication apparatuses when the communication apparatus of the present embodiment transmits a broadcast frame;

FIG. 9C illustrates an antenna pattern and a positional relationship between communication apparatuses when the communication apparatus of the present embodiment duplicates and transmit a broadcast frame;

FIG. 10 illustrates another exemplary transmission procedure in which the communication apparatus of the present embodiment transmits a broadcast frame and that is different from the procedure in FIG. 8;

FIG. 11 illustrates a procedure of controlling starting and ending of a link maintenance timer by a communication apparatus of another embodiment; and

FIG. 12 illustrates an SSW feedback frame format.

### DESCRIPTION OF EMBODIMENTS

Hereinafter, embodiments of the present invention will be described in detail with reference to the drawings as appropriate. However, any unnecessarily detailed description may be omitted. For example, detailed descriptions of well-known matters and redundant descriptions of substantially the same configuration may be omitted. This is to avoid the unnecessary redundancy of the following description and to facilitate understanding by a person skilled in the art.

Note that, the accompanying drawings and the following description are provided for a person skilled in the art to sufficiently understand the present disclosure, and are not intended to limit the subject matter described in the claims.

Further, component elements common in the drawings are denoted by the same reference numerals. Furthermore, when elements of the same type are described separately, reference numerals are used, such as “vehicle 10A” and “vehicle 10B,” and when elements of the same type are described without being distinguished from each other, only the common number in the reference numerals is sometimes used, such as “vehicle 10.” Note that the “vehicle” may be referred to as a “mobile object” or a “mobility.”

### Embodiment

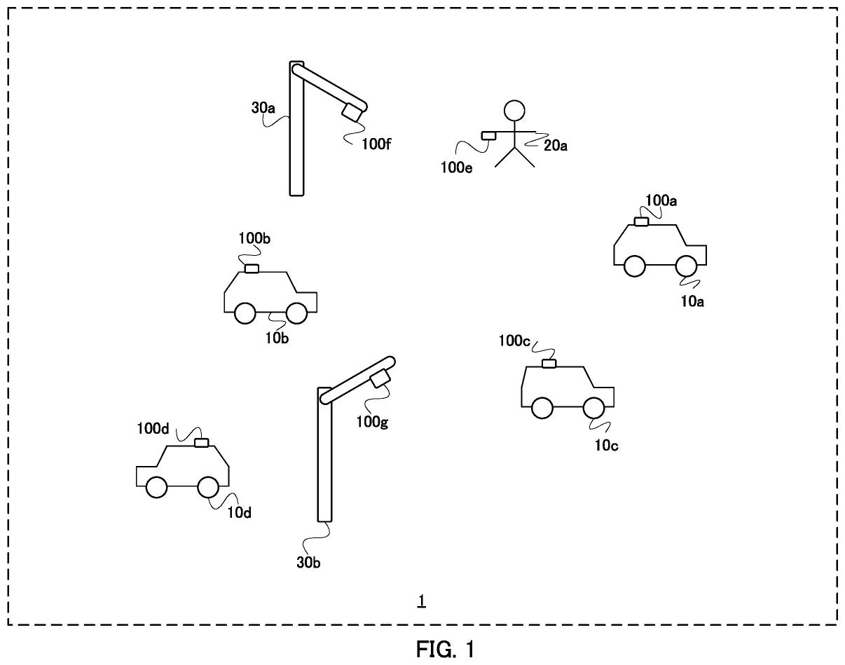

In the following description, a broadcast frame is used as an example of a groupcast frame, but a frame used for transmission may be a multicast frame. FIG. 1 illustrates an exemplary system configuration of vehicle to everything (V2X) communication system 1.

In communication system 1, vehicles 10 (10a, 10b, 10c, and 10d) include communication apparatuses 100 (100a, 100b, 100c, and 100d), respectively. Further, pedestrian 20 (20a) includes communication apparatus 100 (100e). Furthermore, roadside units 30 (30a and 30b) include communication apparatuses 100 (100f and 100g), respectively.

Note that vehicles 10, pedestrian 20, and roadside units 30 may each include a plurality of communication apparatuses 100.

Communication apparatus 100 has a communication function conforming to a millimeter-wave communication system. The communication function may conform to the IEEE802.11ad standard, the IEEE802.11ad-2016 standard, the IEEE802.11ad-2020 standard, the IEEE802.11ay standard (draft), the IEEE802.11bd standard (draft), the IEEE802.15.3c standard, the IEEE802.15.3e standard, and a 3GPP NR (New Radio) system.

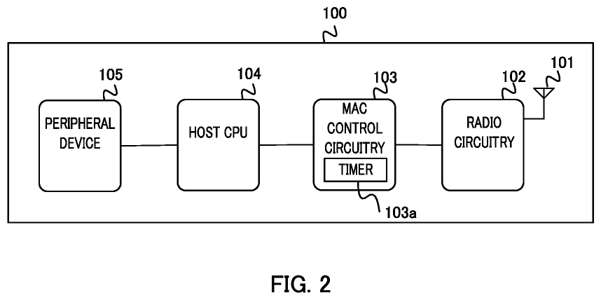

FIG. 2 illustrates an exemplary configuration of a communication apparatus conforming to the IEEE802.11ad standard. FIG. 2 illustrates a configuration of communication apparatus 100. Communication apparatus 100 includes antenna 101, radio circuitry 102, media access control (MAC) control circuitry 103, host central processing unit (CPU) 104, and peripheral device 105. Note that host CPU 104 and MAC control circuitry 103 may be collectively referred to as control circuitry.

Antenna 101 may include one or more antenna elements. Further, antenna 101 may be, for example, a phased array antenna or an array antenna. Antenna 100 may include a transmission antenna and a reception antenna separately or may be communally used for transmission and reception. Antenna 101 may have a function of switching antenna directivity (e.g., referred to as a beam steering function or a beamforming function). A procedure of selecting directivity for performing communication with a communication apparatus of a communication destination with good quality is called beamforming training. Radio circuitry 102 includes radio frequency (RF) circuitry and PHYsical layer (PHY) control circuitry, and performs transmission/reception control of packets defined in the IEEE802.11ad standard and the like. Radio circuitry 102 is sometimes referred to as a transceiver.

MAC control circuitry 103 performs, for example, transmission/reception control of a MAC frame (control frame) defined in the IEEE802.11ad standard. Further, MAC control circuitry 103 controls radio circuitry 102 and controls, for example, a procedure of discovering a communication apparatus of a communication destination (called discovery or scan), a beamforming training procedure, a request to send/clear to send (RTS/CTS) procedure, and a frame transmission procedure. MAC control circuitry 103 includes, for example, timer 103a of a link maintenance timer.

Host CPU 104 executes, for example, a device driver and/or supplicant software, which control MAC control circuitry 103. Host CPU 104 also executes operating system (OS) and application software.

Peripheral device 105 is connected to host CPU 104 and is used by host CPU 104 to execute the software. Peripheral device 105 may include: network enhancement devices, such as a hard disk drive (HDD), a solid state drive (SSD), and an Ethernet controller · Ethernet board; and peripheral devices used for application software of a global navigation satellite system (GNSS).

Next, a method will be described by which communication apparatus 100a conforming to the IEEE802.11ad and mounted in vehicle 10a transmits a DMG beacon frame using transmission beamforming.

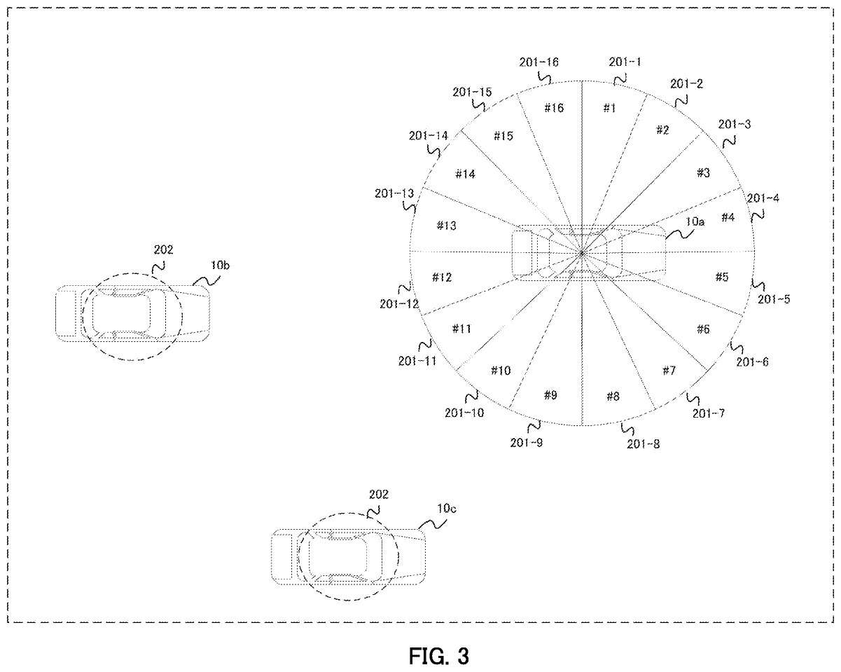

FIG. 3 illustrates an exemplary method by which communication apparatus 100a conforming to the IEEE802.11ad standard performs beamforming.

Communication apparatus 100 controls antenna 101 by beamforming, for example, selects any one of sixteen sectors (201-1 to 201-16, hereinafter, referred to as sectors #1 to #16) or either one of pseudo directional antenna patterns 202 (dotted lines), and performs transmission or reception. Performing transmission by selecting any one of sectors #1 to #16 is referred to as transmission beamforming, and performing reception by selecting any one of sectors #1 to #16 is referred to as reception beamforming.

Communication apparatuses 100b and 100c set antennae 101 to pseudo-omnidirectional pattern 202 and waits for reception. The pseudo-omnidirectional pattern may encompass 360 degrees in a horizontal direction with respect to the vehicle. That is, the pseudo-omnidirectional pattern may be an omnidirectional pattern with respect to a horizontal direction, a vertical direction, or horizontal and vertical directions.

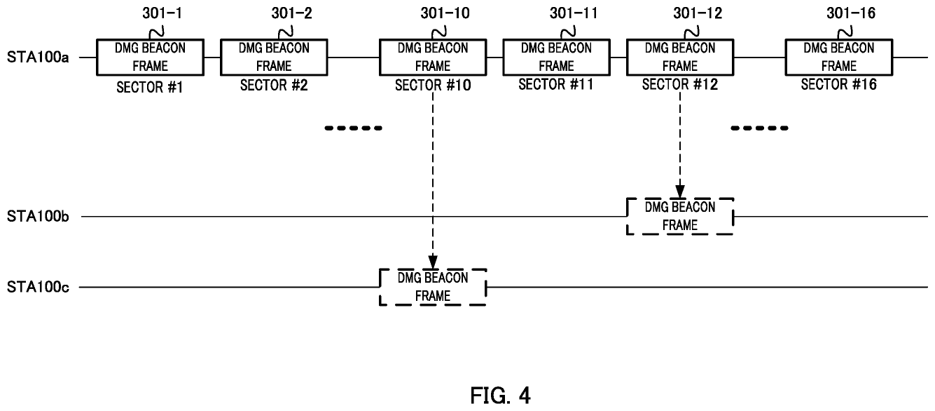

FIG. 4 illustrates a procedure in which communication apparatus 100a (STA 100a) sequentially transmits DMG beacon frame 301 for each sector. Communication apparatus 100a sets antenna 101 in sector #1 and transmits DMG beacon frame 301-1. Next, communication apparatus 100a sets antenna 101 in sector #2 and transmits DMG beacon frame 301-2. Similarly, communication apparatus 100a sequentially sets antenna 101 in sectors #1 to #16 to transmit DMG beacon frames 301-1 to 301-16.

Communication apparatus 100b (STA 100b) is located in the direction of sector #12 of communication apparatus 100a in FIG. 3, for example, and thus receives DMG beacon frame 301-12. Communication apparatus 100c (STA100c) is located in the direction of sector #10 of communication apparatus 100a in FIG. 3, for example, and thus receives DMG beacon frame 301-10.

Accordingly, communication apparatus 100a can transmit DMG beacon frame 301 using transmission beamforming regardless of the directions in which communication apparatuses 100 (100b and 100c) around communication apparatus 100a are located.

However, in the frame transmission procedure in FIG. 4, the number of transmissions of DMG beacon frames 301 increases depending on the number of sectors of antenna 101, and the time required for the entire transmission processing increases. When a data frame having a frame length longer than that of DMG beacon frame 301 is transmitted by the same processing as in FIG. 4, the transmission processing takes a long time, and thus transmission of another data is delayed, which increases a probability that a contention with a data frame transmitted by another communication terminal occurs.

Further, in FIG. 3, communication apparatuses 100b and 100c wait for reception with a pseudo-omnidirectional antenna pattern, so that, when communication apparatus 100a performs transmission in a single carrier PHY (SC-PHY, PHY means a physical layer) or a orthogonal frequency division multiplexing PHY (OFDM-PHY), which are modulation schemes for a data frame, communication apparatuses 100b and 100c possibly have difficulty in reception due to a low reception antenna gain.

Communication apparatus 100a can broadcast a data frame as a broadcast frame.

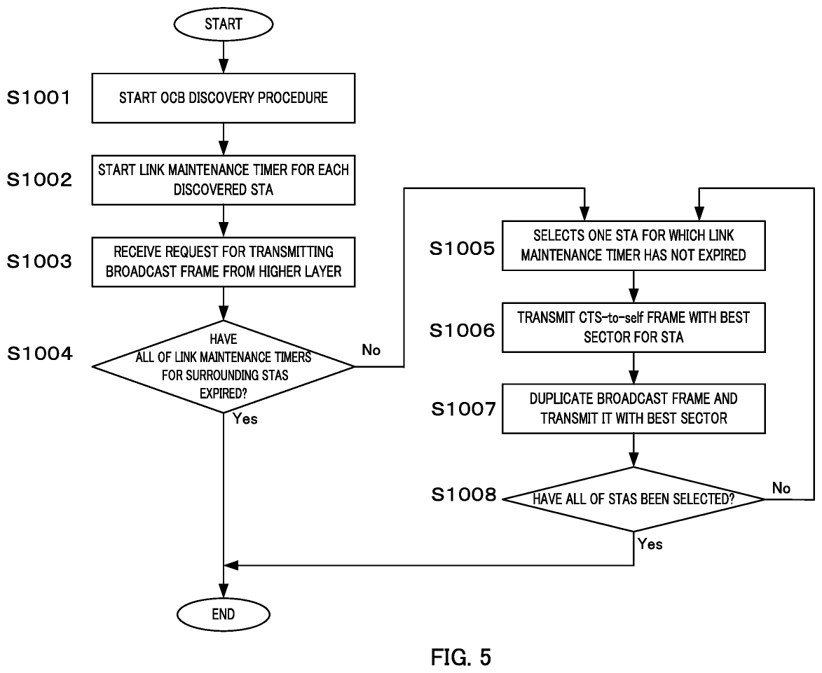

FIG. 5 illustrates a method by which communication apparatus 100a performs broadcast transmission of a broadcast frame using transmission beamforming in the communication system illustrated in FIG. 1. The processing in FIG. 5 is executed by MAC control circuitry 103.

In the communication system in FIG. 1, communication apparatuses 100a, 100b, 100c, and 100d operates out of the context of a Basic Service Set-BSS (OCB). That is, data communication is performed without performing an association procedure or before performing the association procedure.

Communication apparatus 100a, 100b, 100c, and 100d may support a BSS in addition to the OCB. Further, communication apparatus 100 in FIG. 1 may also operate in both or either of OCB and BSS. By way of example, communication apparatus 100a may operate as in an OCB when communicating with communication apparatus 100b and may operate as a station of an infrastructure BSS when communicating with communication apparatus 100f. By way of example, communication apparatus 100a may perform an association procedure with communication apparatus 100f after starting OCB discovery to be described later.

### (Step S1001)

Communication apparatus 100a starts an OCB discovery procedure. Communication apparatus 100a repeatedly transmits a sequence of the DMG beacon frame of FIG. 4 at periodic and/or random intervals until the end of OCB discovery procedure.

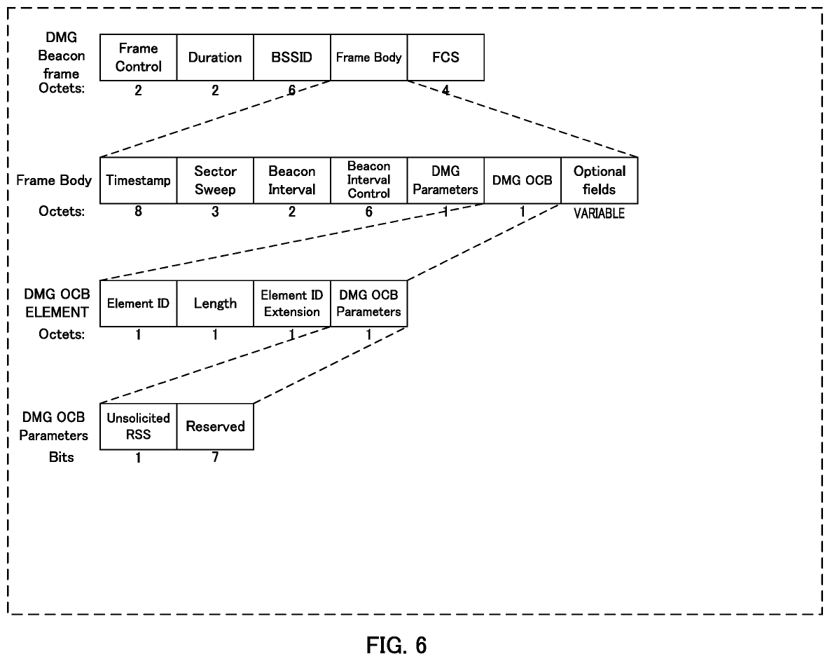

FIG. 6 illustrates a DMG beacon frame format used by communication apparatus 100a in the OCB discovery. Communication apparatus 100a includes a DMG OCB element in the DMG beacon frame and transmits the frame. When communication apparatus 100 that receives the DMG beacon frame supports an OCB, communication apparatus 100 determines whether communication apparatus 100a operates in the OCB based on whether the OCB element is included in the DMG beacon frame.

Communication apparatus 100a discovers communication apparatus 100 by receiving a sector sweep (SSW) frame transmitted by communication apparatus 100 that receives the beacon frame.

### (Step S1002)

Communication apparatus 100a starts a countdown of link maintenance timer 300 every time communication apparatus 100 is discovered in the OCB discovery procedure.

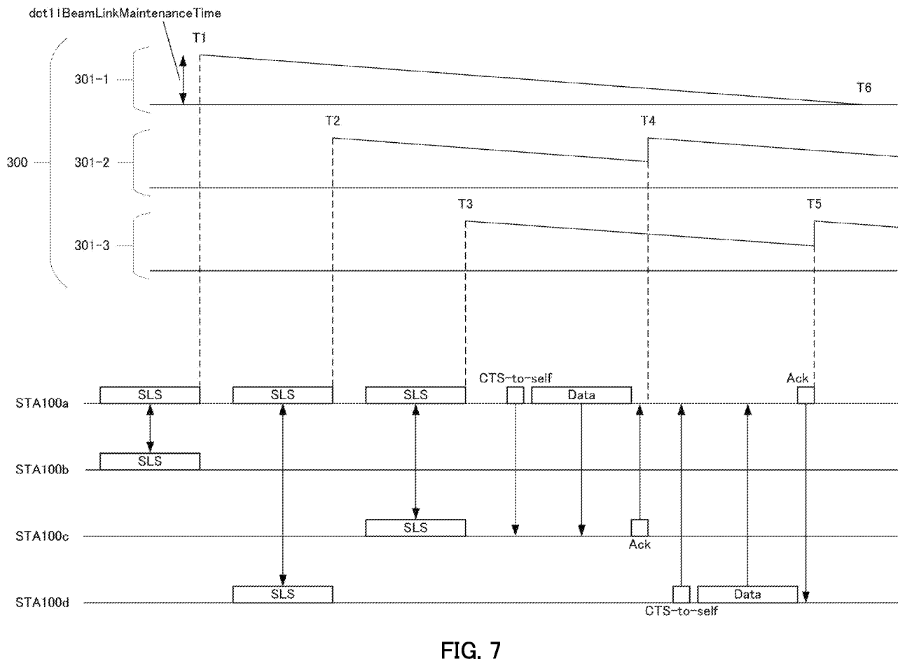

FIG. 7 illustrates an exemplary method by which communication apparatus 100a controls link maintenance timer 300.

Communication apparatus 100a performs sector level sweep (SLS) for communication apparatus 100b. The sector level sweep is a procedure for determining a transmission sector (hereinafter, referred to as a “transmission best sector”) or a reception sector (hereinafter, referred to as a “reception best sector”) with the best radio quality when communicating with another communication apparatus. Note that the transmission best sector may be referred to as another name such as a “transmission best beam.” Similarly, the reception best sector may be referred to as another name such as a “reception best beam.”

As an example of the sector level sweep, the procedure may include transmission of a beacon frame, reception of a sector sweep frame, and transmission of a sector sweep feedback frame. As another example of the sector level sweep, the procedure may include transmission of a sector sweep frame, reception of a sector sweep frame, transmission of a sector sweep feedback frame, and reception of a sector sweep acknowledge frame.

Note that communication apparatus 100a may execute a beam refinement protocol (BRP) to determine the transmission best sector and/or the reception best sector.

After completing the sector level sweep with communication apparatus 100b, communication apparatus 100a sets a value of link maintenance timer 301-1 to a value defined by a valuable dot11BeamLinkMaintenanceTime, and starts a countdown (time T1 in FIG. 7). Note that communication apparatus 100a transmits a unicast frame (a control frame and a data frame) for communication apparatus 100b using the transmission best sector for communication apparatus 100b.

Note that, after completing sector level sweep with communication apparatus 100a, communication apparatus 100b starts a countdown of a link maintenance timer (not illustrated) for communication apparatus 100a.

After completing sector level sweep with communication apparatus 100d, communication apparatus 100a starts a countdown of link maintenance timer 301-2 for communication apparatus 100c (time T2).

After completing sector level sweep with communication apparatus 100c, communication apparatus 100a starts a countdown of link maintenance timer 301-3 for communication apparatus 100d (time T3).

At time T3, communication apparatus 100a operates link maintenance timers 301-1, 301-2, and 301-3 for communication apparatuses 100b, 100c, and 100d, respectively. In other words, link maintenance timer 300 of communication apparatus 100a includes link maintenance timers 301-1, 301-2, and 301-3 for communication apparatuses 100b, 100c, and 100d, respectively.

Communication apparatus 100a resets a link maintenance timer when receiving or transmitting any of an Ack, a BlockAck, and a DMG CTS frame, and sets a value of timer to a valuable dot11BeamLinkMaintenanceTime. Communication apparatus 100a receives an Ack frame from communication apparatus 100c at time T4 in FIG. 7, and thus resets link maintenance timer 301-2 for communication apparatus 100c. Further, communication apparatus 100a transmits an Ack frame to communication apparatus 100d at time T5, and thus resets link maintenance timer 301-3 for communication apparatus 100d.

The value of the link maintenance timer being 0 refers to that the link maintenance timer has expired. Link maintenance time 301-1 expires at time T6 in FIG. 7, and thus communication apparatus 100a ends the control by link maintenance timer 301-1 for communication apparatus 100b. In other words, link maintenance timer 300 of communication apparatus 100a excludes link maintenance timer 301-1 for communication apparatus 100b.

### (Step S1003)

When MAC control circuitry 103 of communication apparatus 100a receives a broadcast transmission request from a control device in the higher layer, MAC control circuitry 103 starts a procedure of transmitting a broadcast frame (steps S1004 to S1008).

The control device in the higher layer is, for example, a program that operates on host CPU 104. The control device in the higher layer may be a program, software, or circuitry that controls an LLC sublayer, an IP layer, and communication functions based on the IEEE1609 standard.

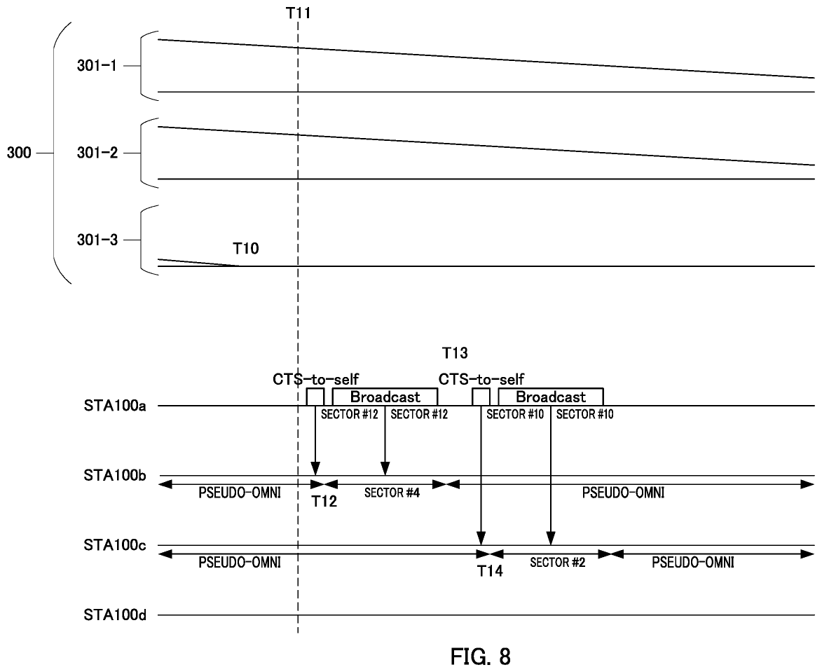

The phrase “receives a broadcast transmission request” means, for example, that MAC control circuitry 103 receives MA-UNITDATA.request primitive defined in the IEEE802.11-2020 standard and/or MA-UNITDATAX.request primitive defined in the IEEE1609.3-2020 standard from the higher layer or the like, or that host CPU 104 passes information including a destination address and transmission data to MAC control circuitry 103 using a shared memory, a bus, a high-speed serial communication, and/or the like. An exemplary procedure in which communication apparatus 100a performs a procedure of transmitting a broadcast frame will be described with reference to FIG. 8. Note that the steps in FIG. 5 continues to be referred for the corresponding procedure.

### (Step S1004)

Communication apparatus 100a determines whether all of link maintenance timers for communication apparatuses 100 (100b, 100c, and 100d) around communication apparatus 100a have expired.

When it is determined that all of the link maintenance timers for communication apparatuses 100 around communication apparatus 100a have expired, communication apparatus 100a ends the procedure of transmitting a broadcast frame. Note that communication apparatus 100a may continue the OCB discovery procedure until a stop request is sent from the higher layer.

As an example, a case will be described in which communication apparatus 100a receives a broadcast frame transmission request at time T11 in FIG. 8. Link maintenance timer 301-3 has expired at time T10, and link maintenance timers 301-1 and 301-2 are active at time T11. Thus, communication apparatus 100a determines that link maintenance timers for communication apparatuses 100b and 100c have not expired.

When all of link maintenance timers for communication apparatuses 100 around communication apparatus 100a have expired, communication apparatus 100a may indicate a transmission error to the higher layer.

When all of link maintenance timers for communication apparatuses 100 around communication apparatus 100a have expired, communication apparatus 100a may transmit a DMG beacon frame and/or an SSW frame to discover surrounding communication apparatuses. Then, when discovering surrounding communication apparatus 100, communication apparatus 100a may transmit a broadcast frame to communication apparatus 100.

Further, when communication apparatus 100a performs OCB discovery and transmits DMG beacon frames periodically and/or at random intervals, communication apparatus 100a may suspend transmission of a broadcast frame after receiving a transmission request for the broadcast frame, and transmit the broadcast frame after transmitting a DMG beacon frame and completing SLS.

Accordingly, communication apparatus 100a can discover communication apparatus 100 around communication apparatus 100a by SLS, and can transmit a broadcast frame to larger number of communication apparatuses 100.

### (Step S1005)

Communication apparatus 100a selects one surrounding communication apparatus for which the link maintenance timer has not expired. For example, at time T11 in FIG. 8, communication apparatus 100a selects communication apparatus 100b.

### (Step S1006)

Communication apparatus 100a sets the antenna pattern of antenna 101 in the transmission best sector (e.g., sector #10) for selected communication apparatus 100b, and transmits a CTS-to-self frame. Communication apparatus 100a may transmit a DMG CTS-to-self frame instead of the CTS-to-self frame.

Communication apparatus 100b does not know when communication apparatus 100a transmits the frame. Thus, communication apparatus 100b sets antennae 101 to pseudo-omnidirectional pattern 202 and waits for reception so that communication apparatus 100b can receive a transmission frame from another communication apparatus.

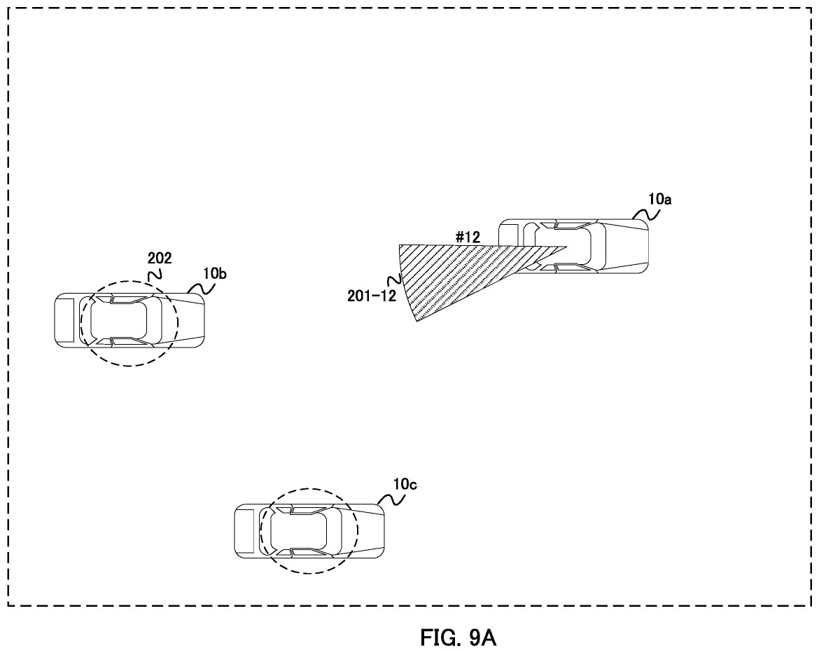

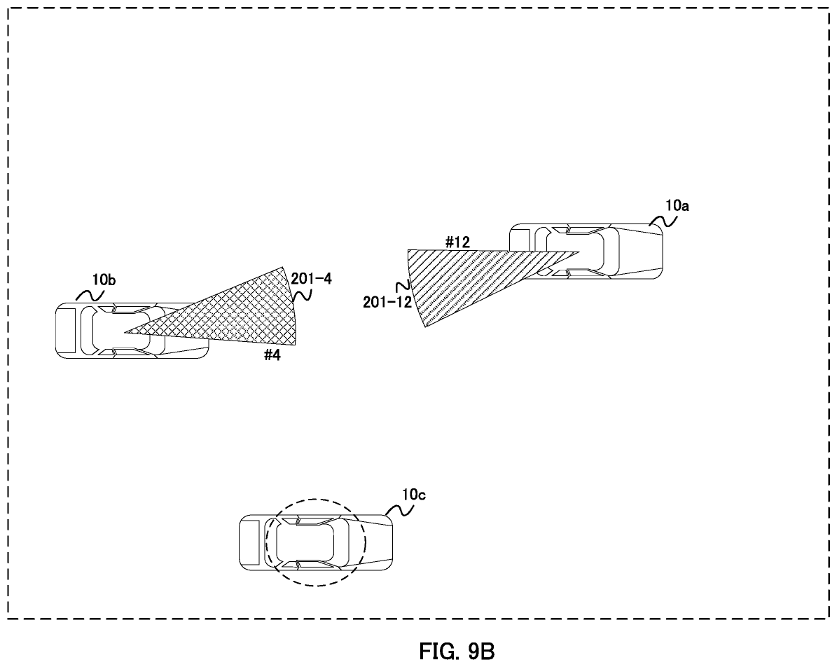

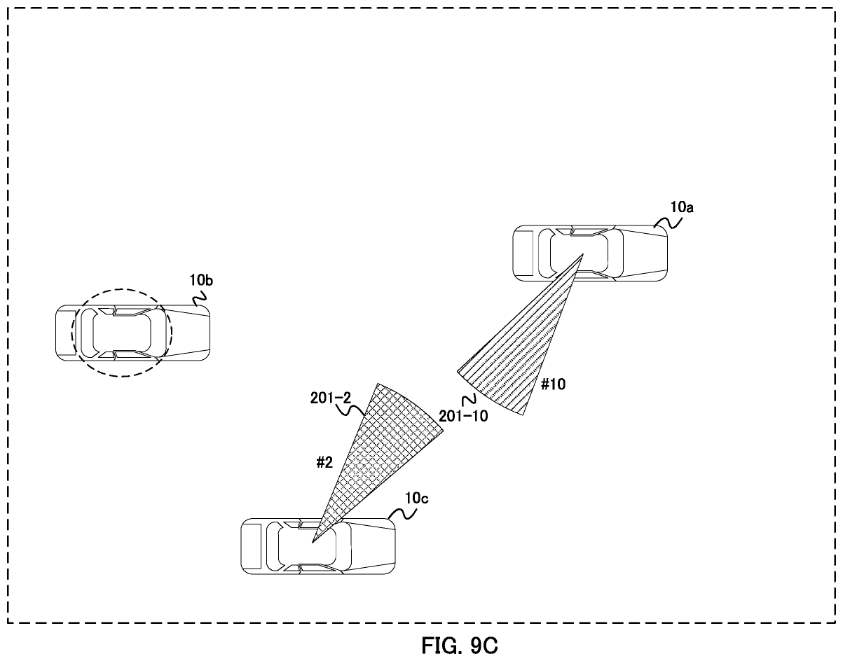

FIG. 9A illustrates an antenna pattern and a positional relationship between communication apparatuses when communication apparatus 100a mounted in vehicle 10a transmits a CTS-to-self frame.

Communication apparatus 100b mounted in vehicle 10b waits with omni-directional antenna pattern 202. Communication apparatus 100a transmits a CTS-to-self frame using sector 201-12 (sector #12), which is the best sector for communicating with communication apparatus 100b. In other words, communication apparatus 100a transmits the CTS-to-self frame while directing the beam toward vehicle 10b. Communication apparatus 100a transmits the CTS-to-self frame using a control PHY scheme, for which required sensitivity is low, so that communication apparatus 100b can receives the CTS-to-self frame by receiving it by the pseudo omni-antenna pattern.

When receiving the CTS-to-self frame, communication apparatus 100b switches antenna 101 to the reception best sector (e.g., sector #4) for communication apparatus 100a and stands by.

### (Step S1007)

Communication apparatus 100a sets the antenna pattern of antenna 101 in the transmission best sector (e.g., sector #10) for selected communication apparatus 100b, and transmits a broadcast frame. Communication apparatus 100a may duplicate and transmit the broadcast frame in order to repeat the procedures of S1005 to S1008 one or more times.

FIGS. 9B and 9C each illustrate an antenna pattern and a positional relationship between communication apparatuses when communication apparatus 100a duplicates and transmits a broadcast frame to each of a plurality of communication apparatuses 100b and 100c.

Communication apparatus 100b waits with best reception sector 201-4 (sector #4) for communication apparatus 100a. Communication apparatus 100a transmits a broadcast frame using transmission best sector 201-12 (sector #12) for communication apparatus 100b.

Communication apparatus 100c waits with reception best sector 201-2 (sector #2) for communication apparatus 100a. Communication apparatus 100a transmits a duplicated broadcast frame using transmission best sector 201-10 (sector #10) for communication apparatus 100c.

The duplicated broadest frame herein means that the same data transmission is performed but the antenna pattern used by communication apparatus 100a is different between communication apparatus 100b and communication apparatus 100c. Further, in FIGS. 9B and 9C, when there is a plurality of communication apparatuses 100 that can receive a broadcast frame transmitted by communication apparatus 100a, the number of transmissions of broadcast frames may be one.

Communication apparatus 100a may transmit the broadcast frame using an SC-PHY or OFDM-PHY. Communication apparatus 100b waits with the reception best sector, so that communication apparatus 100b can receive the broadcast frame at a low packet error rate even when an SC-PHY or OFDM-PHY for which required sensitivity is higher than a Control PHY is used.

The SC-PHY or OFDM-PHY has a data rate ten times higher than that of the control PHY, and thus can transmit a broadcast frame in a short time.

Note that, when a multicast frame is used instead of the broadcast frame as a groupcast frame, the multicast address used in step S1007 may be transmitted while being included in the DMG beacon frame transmitted in step S1001, and may be indicated to the surrounding communication apparatuses. Accordingly, it is possible to omit the procedures of joining and leaving a multicast group in a V2X environment where vehicles frequently approach and leave, and to transmit a multicast frame efficiently and with low delay.

### (Step S1008)

When there is an unselected communication apparatus in step S1005, communication apparatus 100a repeatedly performs steps S1005, S1006, S1007, and S1008. In step S1005, an unselected communication apparatus is selected. In other words, a communication apparatus to which a broadcast frame has not been transmitted is selected.

In the method of transmitting a DMG beacon frame in FIG. 4, transmission need to be performed by duplicating a large number of frames so as to cover the directions covered by a pseudo-omnidirectional antenna of antenna 101 of communication apparatus 100, whereas, in the procedure in FIG. 5, broadcast frames can be transmitted with a small number of transmissions depending on the surrounding communication apparatuses. This can shorten the time for transmission of the broadcast frame, reduce power consumption of the communication apparatus, and reduce interference to another communication apparatus.

In other words, communication apparatus 100a lists communication apparatuses for which the link maintenance timers have not expired, determines one or more transmission sectors in which a broadcast frame is to be transmitted among transmission best sectors for respective communication apparatuses, performs transmission using the sector, and omits transmission using sectors other than the determined sector. The phrase “omits transmission using sectors other than the determined sector” herein includes omitting transmission using sectors that are not the transmission best sector by communication apparatus 100a and omitting transmission using the transmission best sector for a communication apparatus for which the link maintenance timer by communication apparatus 100a has expired.

In the example in FIG. 8, communication apparatus 100a including a transmission sector illustrated in FIG. 2 transmits duplicated broadcast frames for sectors #10 and #12, and omits transmission for sectors #1 to 9, #11, and #13 to #16.

As described above, communication apparatus 100a starts a countdown of the link maintenance timer for the communication apparatus discovered by OCB discovery, selects a communication apparatus for which a corresponding link maintenance timer has not expired, and duplicates and transmits a broadcast frame, which can shorten the time for transmission of the broadcast frame, reduce the power consumption of the communication apparatus, and reduce interference to another communication apparatus.

Further, communication apparatus 100a starts a countdown of the link maintenance timer for communication apparatus 100 around communication apparatus 100a discovered by OCB discovery, selects, to transmit a CTS-to-self frame, surrounding communication apparatus 100 for which the link maintenance timer has not expired, and duplicates and transmits a broadcast frame using an SC-PHY scheme, which can improve a data rate on transmission of a broadcast frame, shorten the time required for the transmission, and reduce interference to another communication apparatus.

### Other Embodiments

Communication apparatus 100a may temporarily stop a countdown of a link maintenance timer from when determining “No” in step S1004 until when determining “Yes” in step S1008. In other words, the countdown of the link maintenance timer may be temporarily stopped during the procedure of transmitting the broadcast frame.

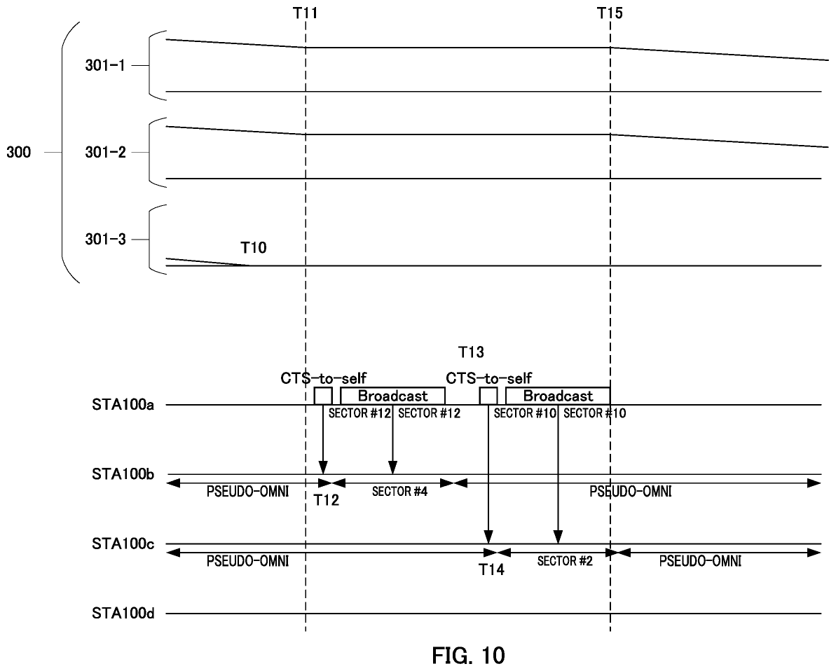

FIG. 10 illustrates another exemplary transmission procedure that is different from the procedure in FIG. 8 and in which communication apparatus 100a transmits a broadcast frame. Description of the same parts as those in FIG. 8 is omitted.

At time T11, communication apparatus 100a starts a procedure of transmitting a broadcast frame and stops countdowns of link maintenance timers 301-1 and 301-2. When determining that not all of the link maintenance timers for communication apparatuses 100 around communication apparatus 100a have expired (No) in step S1004 in FIG. 5, communication apparatus 100a may temporarily stop the countdown of the link maintenance timer.

Communication apparatus 100a temporarily stops countdowns of link maintenance timers 301-1 and 301-2 until the procedure of transmitting the broadcast frames is completed (from time T11 to time T15).

In the procedure in FIG. 8, the link maintenance timer possibly expires during the procedure of transmitting the broadcast frame, and the duplicated broadcast frame is not possibly transmitted depending on the order of the terminals selected in step S1005. In contrast, in the procedure in FIG. 10, the duplicated broadcast frame is transmitted to the communication apparatuses around the communication apparatus regardless of the order of the terminals selected in step S1005.

As described above, because communication apparatus 100a temporarily stops the countdown of the link maintenance timer during the procedure of transmitting the broadcast frame, the duplicated broadcast frames are transmitted to the communication apparatuses around the communication apparatus regardless of the order of transmitting the duplicated broadcast frames, which avoids missing of transmission.

When the link maintenance timer expires during OCB discovery, communication apparatus 100 performs SLS with the corresponding communication apparatus, and when SLS does not succeed, communication apparatus 100 determines that the corresponding communication apparatus has moved outside the communication range, and indicates the determination to the higher layer.

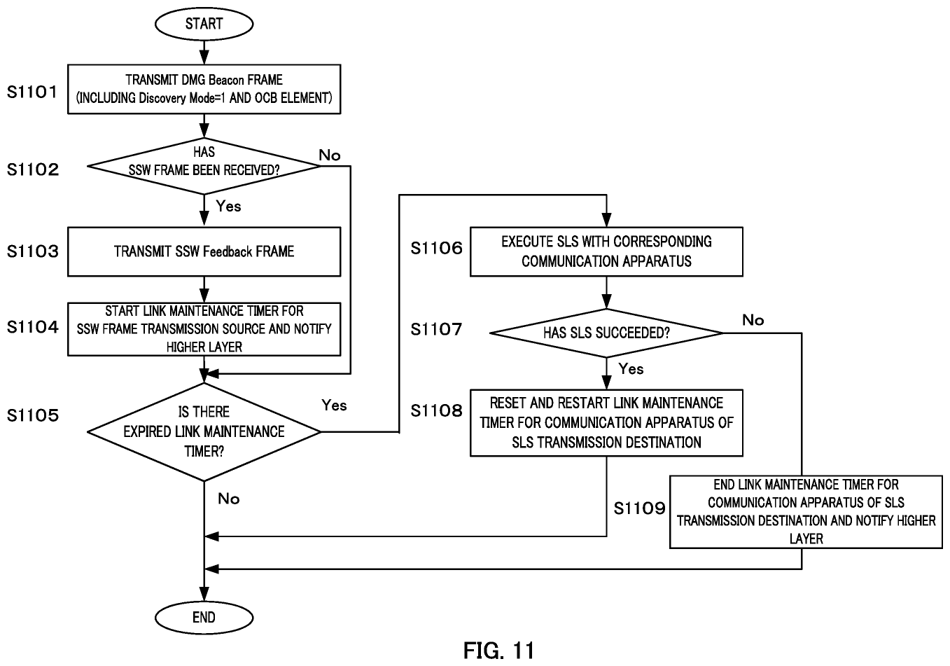

FIG. 11 illustrates an exemplary procedure in which communication apparatus 100 controls starting and ending of a countdown of a link maintenance timer. The procedure in FIG. 11 is mainly controlled by MAC control circuitry 103.

### (Step S1101)

Communication apparatus 100 includes an OCB element in a DMG beacon frame and sets a Discovery Mode field to 1 to transmit the beacon frame.

### (Step S1102)

When communication apparatus 100 receives an SSW frame and the OCB subfield is 1, communication apparatus 100 determines that a response has been obtained from the communication apparatus operating in an OCB, and proceeds to step S1103. When the OCB subfield is 0, steps S1103 and S1104 are omitted.

Note that when communication apparatus 100 receives an SSW frame and the OCB subfield value is 0, communication apparatus 100 may transmit an SSW feedback frame and wait for an association request frame for starting a personal basic service set (PBSS).

### (Step S1103)

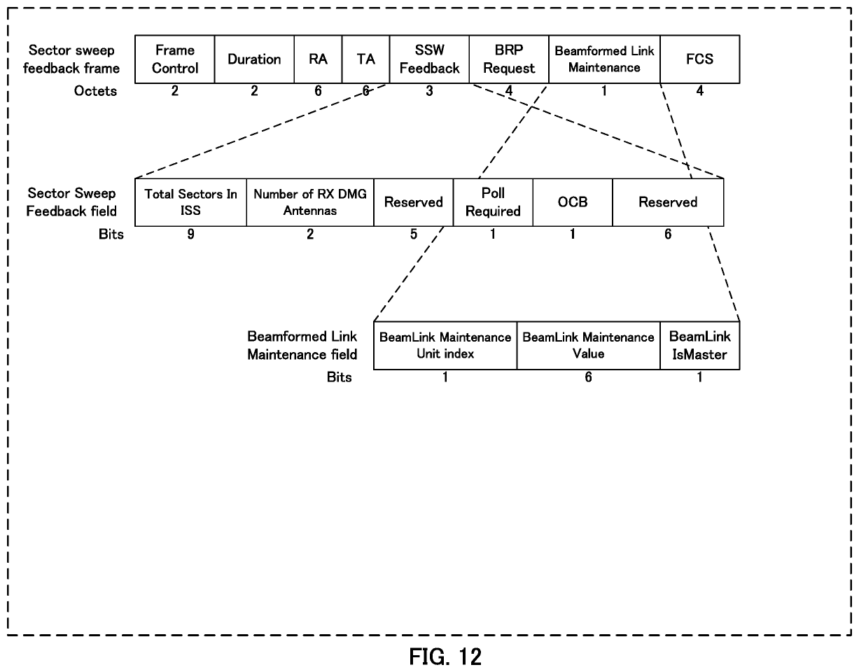

Communication apparatus 100 transmits an SSW feedback frame. FIG. 12 illustrates an SSW feedback frame format.

Communication apparatus 100 sets 1 in the OCB subfield to indicate that communication apparatus 100 operates in an OCB. Further, communication apparatus 100 sets a request value of dot11BeamLinkMaintenanceTime in a Beamformed Link Maintenance field.

The IEEE802.11-2020 standard describes a method of determining an adjusted value of dot11BeamLinkMaintenanceTime from values of Beamformed Link Maintenance fields transmitted by two communication apparatuses that communicate with each other. Meanwhile, communication apparatus 100 in the procedure in FIG. 11 determines the value of dot11BeamLinkMaintenanceTime based only on the value of a Beamformed Link Maintenance field of an SSW feedback frame transmitted in step S1103.

Further, when the value of OCB subfield is 1, the communication apparatus that has received the SSW feedback frame determines the value of dot11BeamLinkMaintenanceTime based only on the value of the Beamformed Link Maintenance field of the received SSW feedback frame.

Accordingly, communication apparatus 100 can start a countdown of a link maintenance timer at an early stage for the communication apparatus discovered in the OCB discovery procedure, and can transmit a broadcast frame at an early stage by using the procedure in FIG. 5.

### (Step S1104)

Communication apparatus 100 starts a countdown of the link maintenance timer for the communication apparatus of the transmission source of step S1102. Further, communication apparatus 100 indicates, to the higher layer, the discovery of the communication apparatus of the transmission source. Communication apparatus 100 may perform the indication to the higher layer, including a MAC address of the communication apparatus of the transmission source and the information on an SSW feedback field included in the received SSW frame.

The higher layer may manage the list of the indicated communication apparatuses and determine whether to transmit a WAVE Service Advertisement (WSA) frame defined in the IEEE1609 standard by millimeter-wave communication. For example, when all of the communication apparatuses included in the list comprise another communication system, for example, 5.9 GHz band V2X communication, the transmission of the WSA frame in the millimeter wave may be stopped.

### (Step S1105)

Communication apparatus 100 determines whether there is an expired link maintenance timer, and when communication apparatus determines as Yes, the procedure goes to step S1106, and when communication apparatus determines as No, the processing ends.

### (Steps S1106 and S1107)

Communication apparatus 100 performs sector level sweep with the communication apparatus corresponding to the expired link maintenance timer.

### (Step S1108)

When the sector level sweep succeeds, the expired link maintenance timer is reset, the value of the timer is set to the value of a valuable dot11BeamLinkMaintenanceTime, and the countdown is restarted.

### (Step S1109)

When the sector level sweep does not succeed, in other words, when communication apparatus 100 receives no SSW frame or SSW Ack frame, communication apparatus 100 ends the expired link maintenance timer by excluding it from link maintenance timer 300 and indicates, to the higher layer, that the link maintenance timer for the communication apparatus corresponding to the expired link maintenance timer has expired.

The higher layer receives the indication, determines that the communication with the corresponding communication apparatus in a millimeter wave has been interrupted, and excludes the corresponding communication apparatus from the list of communication apparatuses.

Note that, in a case where communication apparatus 100 does not operate in an OCB, when the sector level sweep executed due to the expiration of link maintenance timer does not succeed, communication apparatus 100 does not perform the indication to the higher layer. When communication apparatus 100 does not operate in an OCB, communication apparatus 100 needs to repeat attempt at sector level sweep with a communication partner to join a BSS until de-association is executed.

In the case where communication apparatus 100 performs communication in a V2X environment as illustrated in FIG. 1, the procedure in FIG. 11 eliminates the need of repeating attempt at sector level sweep for a communication apparatus that is far away from communication apparatus 100, which can reduce power consumption and interference to another communication apparatus.

As described above, when the OCB field of the SSW feedback frame is 1, communication apparatus 100 determines the value of dot11BeamLinkMaintenanceTime based only on the value of a Beamformed Link Maintenance field of an SSW feedback frame, so that the countdown of the link maintenance timer for the discovered communication apparatus can be started at an early stage and the broadcast frame can be transmitted at an early stage.

Further, when operating in an OCB, communication apparatus 100 indicates, to the higher layer, that sector level sweep for the communication apparatus for which the link maintenance timer has expired does not succeed, so that the higher layer can know the list of communication apparatuses to which broadcast frames reach using a millimeter wave, and thus unnecessary transmission of broadcast frames can be reduced.

Although the embodiments have been described above with reference to the drawings, the present disclosure is not limited to these examples. Obviously, a person skilled in the art would arrive variations and modifications within a scope described in claims. It is understood that these variations and modifications are within the technical scope of the present disclosure. Further, component elements in the embodiments may be optionally combined without departure from the spirit of the present disclosure.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

Further, the technique of implementing an integrated circuit is not limited to the LSI and may be realized by using a dedicated circuit, a general-purpose processor, or a special-purpose processor. Furthermore, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication apparatus performing a function of communication described in the present disclosure. For example, the communication apparatus may comprise a controller or a sensor that generates control signals or data signals which are used by a communication apparatus performing a communication function of the communication apparatus.

The communication apparatus also may include an infrastructure facility, such as a base station, an access point, and any other apparatus, device or system that communicates with or controls apparatuses such as those in the above non-limiting examples.

### Summary of Present Disclosure

A communication apparatus according to the present disclosure includes: MAC control circuitry, which, in operation, controls a procedure of discovering a communication partner apparatus and a procedure of determining a transmission best sector in which a radio communication quality with the communication partner apparatus is best; and radio circuitry, which, in operation, transmits a unicast frame to the communication partner apparatus using the transmission best sector, in which the MAC control circuitry starts a timer for each of a plurality of the discovered communication partner apparatuses after the procedure of discovering the communication apparatus is completed, and controls the radio circuitry to transmit a groupcast frame using the transmission best sector for the communication partner apparatus for which the timer has not expired, when receiving a request for transmitting the groupcast frame from a higher layer before all of a plurality of the timer expires.

In the communication apparatus according to the present disclosure, when receiving an Ack frame from the communication partner apparatus, the MAC control circuitry restarts the timer for the communication partner apparatus that has transmitted the Ack frame.

In the communication apparatus according to the present disclosure, when there is a plurality of the communication partner apparatuses for which the timers have not expired, the MAC control circuitry controls the radio circuitry to duplicate the groupcast frame and to transmit the groupcast frame using the transmission best sector for each of the plurality of communication partner apparatuses.

In the communication apparatus according to the present disclosure, when receiving a sector sweep (SSW) frame in the groupcast frame, the MAC control circuitry starts the timer for the communication partner apparatus that has transmitted the SSW frame.

In the communication apparatus according to the present disclosure, when the communication apparatus operates out of the context of a basic service set—BSS (OCB), the MAC control circuitry executes sector level sweep for the communication partner apparatus for which the timer has expired, and notifies a higher layer when the sector level sweep does not succeed.

A communication apparatus according to the present disclosure includes: MAC control circuitry, which, in operation, controls a procedure of discovering a communication partner apparatus and a procedure of determining a transmission best sector in which a radio communication quality with the communication partner apparatus is best; and radio circuitry, which, in operation, transmits a unicast frame to the communication partner apparatus using the transmission best sector, in which the MAC control circuitry starts a timer for each of a plurality of the discovered communication partner apparatuses after the procedure of discovering the communication partner apparatuses is completed, and controls the radio circuitry to omit transmission of a groupcast frame when receiving a request for transmitting the groupcast frame from a higher layer before all of a plurality of the timers expires, the transmission using the transmission best sector for the communication partner apparatus for which the timer has expired.

A communication apparatus according to the present disclosure includes: MAC control circuitry, which, in operation, controls a procedure of discovering a communication partner apparatus and a procedure of determining a transmission best sector in which a radio communication quality with the communication partner apparatus is best; and radio circuitry, which, in operation, transmits a unicast frame to the communication partner apparatus using the transmission best sector, in which the MAC control circuitry starts a timer for each of a plurality of the discovered communication partner apparatuses after the procedure of discovering the communication partner apparatuses is completed, and controls the radio circuitry to omit transmission of a groupcast frame when receiving a request for transmitting the groupcast frame from a higher layer before all of a plurality of the timers expires, the transmission being performed using a sector different from the transmission best sector for the communication partner apparatus for which the timer has not expired.

A communication method includes: executing a procedure of discovering a communication partner apparatus; executing a procedure of determining a transmission best sector in which a radio communication quality with the discovered communication partner apparatus is best; transmitting a unicast frame to the discovered communication partner apparatus using the transmission best sector; starting a timer for each of a plurality of the discovered communication partner apparatuses after the procedure of discovering the communication partner apparatus is completed; and transmitting, by using the transmission best sector, a groupcast frame to the communication partner apparatus for which the timer has not expired when receiving a request for transmitting the groupcast frame from a higher layer before all of a plurality of the timers expires.

The present patent application claims the benefit of priority based on Japanese Patent Application No. 2021-123415 filed on Jul. 28, 2021, and the entire content of Japanese Patent Application No. 2021-123415 is hereby incorporated by reference.

### Industrial Applicability

The present disclosure is suitable, for example, for millimeter-wave communication performed by being mounted in a high-speed mobile object.

### REFERENCE SIGNS LIST

10 (10a to 10m) Vehicle
20 Pedestrian
30 Roadside unit
100 (100a to 100m) Communication apparatus
101 Antenna
102 Radio circuitry
103 MAC control circuitry
103a Timer
104 Host CPU
105 Peripheral device

1. A communication apparatus, comprising:
MAC control circuitry, which, in operation, controls a procedure of discovering a plurality of communication partner apparatuses and a procedure of determining a plurality of transmission best sectors in which respective radio communication qualities with the plurality of communication partner apparatuses are best; and
radio circuitry, which, in operation, transmits a unicast frame to each of the plurality of communication partner apparatuses using a corresponding one of the plurality of transmission best sectors, wherein
the MAC control circuitry
starts a timer for each of the discovered plurality of communication partner apparatuses after the procedure of determining the plurality of transmission best sectors is completed, and
controls, when receiving a request for transmitting a groupcast frame from a higher layer, the radio circuitry to transmit the groupcast frame using a different antenna pattern for each of at least one of the plurality of communication partner apparatuses for which the timer is active.

2. The communication apparatus according to claim 1, wherein
the MAC control circuitry generates information on at least one of the plurality of communication partner apparatuses for which the started timer has expired.

3. The communication apparatus according to claim 1, wherein
the MAC control circuitry generates, in a case of non-operation in which the procedure of discovering the plurality of communication partner apparatuses does not operate, no information on the non-operation.

4. The communication apparatus according to claim 1, wherein
the MAC control circuitry performs the procedure of discovering the plurality of communication partner apparatuses while omitting an association procedure or before the association procedure.

5. The communication apparatus according to claim 1, wherein
the MAC control circuitry restarts, when receiving an Ack frame from at least one of the plurality of communication partner apparatuses, the timer for the at least one of the plurality of communication partner apparatuses that has transmitted the Ack frame.

6. The communication apparatus according to claim 1, wherein
the MAC control circuitry starts, when receiving a sector sweep (SSW) frame in the groupcast frame, the timer for at least one of the plurality of communication partner apparatuses that has transmitted the SSW frame.

7. The communication apparatus according to claim 1, wherein
when the communication apparatus operates out of the context of a basic service set—BSS (OCB),
the MAC control circuitry
executes sector level sweep for at least one of the plurality of communication partner apparatuses for which the timer has expired, and
notifies the higher layer when the sector level sweep does not succeed.

8. A communication apparatus, comprising:
MAC control circuitry, which, in operation, controls a procedure of discovering a plurality of communication partner apparatuses and a procedure of determining a plurality of transmission best sectors in which respective radio communication qualities with the plurality of communication partner apparatuses are best; and
radio circuitry, which, in operation, transmits a unicast frame to each of the plurality of communication partner apparatuses using a corresponding one of the plurality of transmission best sectors, wherein
the MAC control circuitry
starts a timer for each of the discovered plurality of communication partner apparatuses after the procedure of determining the plurality of transmission best sectors is completed, and
controls, when receiving a request for transmitting a groupcast frame from a higher layer, the radio circuitry to omit transmission of the groupcast frame, the transmission using at least one of the plurality of transmission best sectors for at least one of the plurality of communication partner apparatuses for which the timer has expired.

9. A communication apparatus, comprising:
MAC control circuitry, which, in operation, controls a procedure of discovering a plurality of communication partner apparatuses and a procedure of determining a plurality of transmission best sectors in which respective radio communication qualities with the plurality of communication partner apparatuses are best; and
radio circuitry, which, in operation, transmits a unicast frame to each of the plurality of communication partner apparatuses using a corresponding one of the plurality of transmission best sectors, wherein
the MAC control circuitry
starts a timer for each of the discovered plurality of communication partner apparatuses after the procedure of determining the plurality of transmission best sectors is completed, and
controls, when receiving a request for transmitting a groupcast frame from a higher layer, the radio circuitry to omit transmission of the groupcast frame, the transmission using a sector different from at least one of the plurality of transmission best sectors for at least one of the plurality of communication partner apparatuses for which the timer is active.

10. A communication apparatus, comprising:
executing a procedure of discovering a plurality of communication partner apparatuses;
executing a procedure of determining a plurality of transmission best sectors in which respective radio communication qualities with the discovered plurality of communication partner apparatuses are best;
transmitting a unicast frame to each of the discovered plurality of communication partner apparatuses using a corresponding one of the plurality of transmission best sectors;
starting a timer for each of the discovered plurality of communication partner apparatuses after the procedure of determining the plurality of transmission best sectors is completed; and
transmitting, when receiving a request for transmitting a groupcast frame from a higher layer, the groupcast frame using a different antenna pattern for each of at least one of the plurality of communication partner apparatuses for which the timer is active.
